(19) United States
(12) Patent Application Publication
(10) Pub. No.: US 2006/0026260 A1
(43) Pub. Date: Feb. 2, 2006

(54) Method of communicating between web applications and local client application while maintaining remote user session

(76) Inventors: Jeffrey T. Mullen, Apex, NC (US); Brent Garner, Durham, NC (US)

Correspondence Address: WOMBLE CARLYLE SANDRIDGE & RICE, PLLC, P.O. BOX 7037, ATLANTA, GA, 30357-0037, US

(21) Appl. No.: 10/900,595

(22) Filed: Jul. 28, 2004

(51) Int. Cl. G06F 15/16

(52) U.S. Cl. 709/217

(57) ABSTRACT

A method for non-browser based client applications to be integrated into a user's web session and allowed to transfer information from the non-browser applications to the user's session on the web server. The method provides communications between a web-based application and a client application while maintaining a unique client session with a web server. The web browser requests a web page containing data or any other information needed by the non-browser based client application. When the web server receives the client request, it redirects the client web browser to a second web page which is reloaded on a regular basis in order to prevent the client session with the web server from expiring. The second web page generates a web form that includes a link to a file stored on the web server containing the data or other information for use by the client application. When the second web page is finished loading the first time, it downloads the file to the client device and automatically starts execution of the non-browser based client application. The client application uses the data or other information contained in the downloaded file when the non-browser client application executes. The client application returns the results of its processing to the web server which stores the data or other information to preserve session information. The second web page detects a return criterion that is returned with the results and processes the server file containing the stored results from the non-browser based client application.

### FIELD OF THE INVENTION

The present invention relates generally to client-server communications on a wide area network, such as the Internet. More specifically, the invention relates to methods for communicating information resident on the client to the server while maintaining a web session between the client and server.

### BACKGROUND OF THE INVENTION

Web transactions between a client and server are static in that they require a client to request a page and the web server to respond with the requested page. Modern web servers can maintain knowledge with sessions by assigning an identification (ID) to a user who makes a request from the server. The session ID is then used to track the user's activities thereby providing a consistent experience for the user. However, since all web transactions are client activated, transferring any data from a non-browser application on the client to the server requires a request to the server, thereby creating a session for a different user.

In general, in order to serve web pages, web sites need a host computer and server software that runs on the host computer. The host manages the communications protocols and houses the web pages and related software required to create a web site on the Internet. The server software resides on the host computer and serves up the pages requested from the client browser software. The server handles Hypertext Transfer Protocol (HTTP) requests and communications with the host computer's operating system. More specifically, a web server is an HTTP server that sends information to client browser software using the Hypertext Transfer Protocol.

The client browser requests that the web server return an Hypertext Markup Language (HTML) document. The server responds with a response that includes transmission information and the HTML file. The web server also passes requests to run Common Gateway Interface (CGI) scripts to CGI applications. Such CGI scripts run external programs, such as a database lookup. The server sends the script to the application program via CGI and communicates the results of the script back to the client browser. The server software also includes configuration files and utilities to secure and manage the web site.

Database searches on the server can be performed when a client request a page from the server. On the client side of the database, the user is presented with a form on which to enter search terms. Executing the search launches a CGI script that sends a search command to the web server. The CGI script sends the search to the database, receives the results of the search query along with the HTML page created by the database to contain the result, and passes the HTML page to the web server to send back to the client browser.

In HTML there are two different methods for submitting a form. Form submission is the primary method used to get information from the web client to the web server. The GET method is used when the form submitted contains less than 1 kilobyte (1024 characters) worth of information. This method of submitting also places all of the form information into the URL for the follow up web page (http://site.com/form.cgi?name=Bob&password=tucker&language=EN). The POST method is used when more than 1 kilobyte of information may be passed to the server, and also when that information should not be displayed in the URL. This method works by sending the encoded form data to the standard input of the web server

When a user is logged onto a web server from a client computer, the web server does not have access to information that is stored on the client computer. To maintain security on both the client and the server, any code generated by the server and posted to the client browser at the request of the client does not have access to the client machine as a whole. Other processes running on the client cannot get access to data passed to the client via the HTTP connection with the exception of file downloads (i.e. downloading a Word document to be opened by MS Word). The security model currently compartmentalizes applications to operate either within the browser or within some other type of interface (command line, Windows, etc.) but disallows communication between them.

There is a need for a method that can enable communication between a web application and a client application in order to retrieve relevant information from a client computer and send the information to a web application maintaining a remote session between the server and client.

### SUMMARY OF THE INVENTION

The present invention is directed to a method for integrating non-browser applications with applications running on web servers with session states. It is common today for applications to be web-based in order to provide a uniform presentation for such environments as global corporations and large university systems. However, there still exist many legacy applications crucial to users. It may be costly and time-consuming to reproduce the functionality of these applications for the web environment, but inexpensive to modify the applications to receive and send information in a simple format to communicate with the web server. The inventive method allows these modified applications to communicate with a web server during a user session in a web application and allows these processes to maintain session state during this communication.

In an exemplary embodiment, a method is provided for communicating between a web-based application and a client application while maintaining a unique client session with a web server. The client device, through any available web browser application, initiates the client session with the web server. The web browser requests a web page containing data or any other information needed by the non-browser based client application. When the web server receives the client request, it redirects the client web browser to a second web page which is reloaded on a regular basis in order to prevent the client session with the web server from expiring. The second web page generates a web form (e.g. HTML form) that includes a link to a file stored on the web server containing the data or other information for use by the client application. When the second web page is finished loading the first time, it downloads the file to the client and automatically starts execution of the non-browser based client application. The client application uses the data or other information contained in the downloaded file when the application executes. The client application returns the results of its processing to a third web page on the web server which writes the data or other information returned to another file stored on the web server. The second web page detects a return criterion that is returned with the results and processes the session file containing the stored results from the non-browser based application.

In another more specific embodiment, the present invention is also directed to a method that can integrate the entire spectrum of product configurators in a business organization, such as a product or equipment manufacturer, to configure various products available in the organization under one common web interface or portal regardless of whether a product configurator is web-based or stored on a client computer, e.g., a workstation. The product configurators are varied not only in the products they configure, but also in their application design. Increasingly, product configurators are web-based and can be maintained by standard HTML techniques such as frames. However, a number of product configurators can be Windows applications running on workstations. Therefore, transferring the data from a common configurator platform (CCP) to the product configurators becomes a difficult task when the workstation application must also be aware of the user's web transactions in order to complete the transaction loop. The present invention provides a mechanism for accomplishing this object.

### DESCRIPTION OF DRAWINGS

The invention is better understood by reading the following detailed description of the invention in conjunction with the accompanying drawings.

FIG. 1 illustrates an overview of the process for communicating between a web application and a local client application in accordance with an exemplary embodiment of the invention.

FIG. 2 illustrates the processing logic for communicating between web applications and local client applications during a remote user session in accordance with an exemplary embodiment of the invention.

FIG. 3 illustrates the processing that takes place at the web server and the client machine during a remote user session in accordance with an exemplary embodiment of the invention.

FIGS. 4-8 illustrate the use interface for an exemplary embodiment of the invention used for web-based product configuration.

### DETAILED DESCRIPTION OF THE INVENTION

The following description of the invention is provided as an enabling teaching of the invention in its best, currently known embodiment. Those skilled in the relevant art will recognize that many changes can be made to the embodiments described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and may even be desirable in certain circumstances and are a part of the present invention. Thus, the following description is provided as illustrative of the principles of the present invention and not in limitation thereof, since the scope of the present invention is defined by the claims.

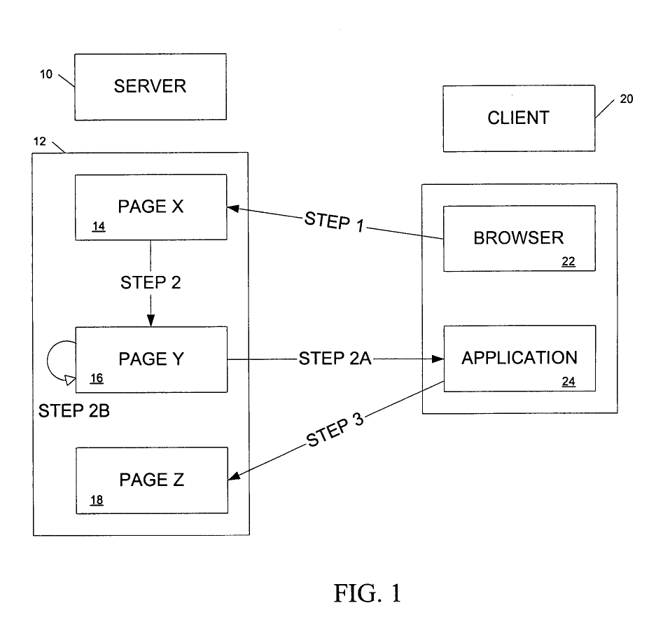

FIG. 1 illustrates an overview of the process for communicating between a web application 12 and a local client application 24 while maintaining a remote user session between web server 10 and client computer 20. The invention can be implemented with a minimum of three web pages 14, 16, 18. Page X 14 is the entry point for the client's web browser 22 (hereafter referred to as “browser”). When the client 20 contacts the web server 10, a session identification is created (step 1). This session uniquely identifies the user (i.e., client 20) to the server 10. Page X 14, when requested, will write to disk any information defined as necessary for the client side application 24 (hereafter referred to as “application”). The file contains some type of marker, which associates the file with the session that created it.

Page X 14 then redirects the browser 22 to page Y 16 (step 2) which contains a instruction to reload itself on a regular basis. This is done in order to prevent the user's session from expiring on the server 10. Page Y 16 maintains a count of the number of times it is loaded. When this count is zero, or the first load, page Y 16 generates a form containing the link to the file generated by page X. The form submits itself when the body of the page Y 16 is finished loading. This submission triggers a download to the client's machine 20 through the browser 22. When the client 20 accepts the download, the application 24 is automatically started (assuming it is already associated with the file type) (step 2a). The user is then able to use the application 24 with the data provided by the web server 10.

While the user performs tasks in the client application 24, page Y 16 continues to reload itself on a regular basis to maintain the session on the server with the reload count greater than zero so that no further downloads are started (step 2b). On each subsequent reload of page Y 16, code is executed which checks for the “return criteria” which will confirm a response from the application 24 running on the client machine 20. When the user is finished with the application 24 and requires the return of information to the web server 10, the application 24 supplies the data to the web server 10 by executing an HTTP POST to page Z 18. Page Z 18 processes the data and writes the data to disk along with the return criteria (step 3). When step 3 is finished, page Y 16 detects the fulfillment of the return criteria on the next reload, opens the file associated with its session and processes the data posted by the application. When the processing is complete, page Y 16 redirects the browser 22 to continue with the web application 12.

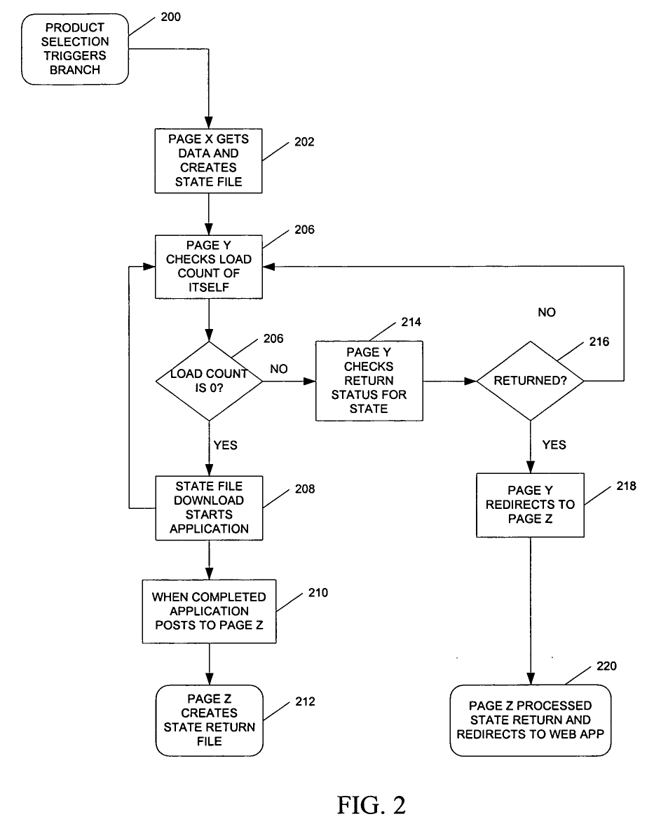

FIG. 2 illustrates the processing logic for communicating between web applications and local client applications during a remote user session. Processing begins in logic block 200 when a user makes a product selection. Generally, product selection refers to a web server application stored on the web server and containing data or other information needed by a client application. This triggers a branch to a corresponding web page. Page X gets data needed for the local client application and creates a STATE file as indicated in logic block 202. STATE describes the data being transferred to the “fat” client. Next, in logic block 204, page Y checks the load count of itself, i.e., the number of times that page Y has been loaded. In decision block 206, a determination is made whether or not the load count is zero. If it is zero, then the State file download to the client browser starts the client application as shown in logic block 208. When the client application completes processing, the client application posts data to page Z as indicated in logic block 210. The client application posts data to a different session. Page Z then creates a STATE RETURN file as indicated in logic block 212. STATE contains session information and STATE RETURN contains correlating STATE session information.

In decision block 206, if the load count is not zero, page Y checks the return status for STATE. This step is indicated in logic block 214. A test is performed in decision block 216 for the return criteria. If the return criteria is fulfilled, page Y redirects to page Z as indicated in logic block 218. Page Z processes the STATE RETURN and redirects to the web application.

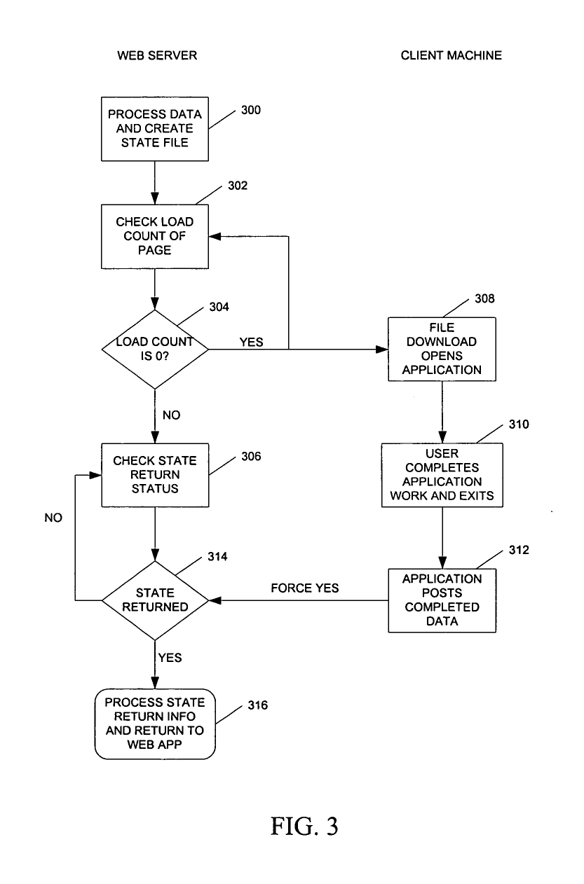

FIG. 3 illustrates the processing that takes place separately at the web server and the client machine over time during a remote user session. On the server side, the web server 10 processes data needed for the client application and creates a STATE file as indicated in logic block 300. The web server application checks the load count in logic block 302. In decision block 304, a test is made to determine if the load count is zero. If yes, the download to the client browser is started. On the client side, the file download opens the client application as indicated in logic block 308. The user/client 20 completes the client application work and exits the client application as indicated in logic block 310. The client application posts the completed data to the web server application as indicated in logic block 312 by a STATE RETURN indication.

In decision block 304, if the load count is not zero, the web server application will then check for STATE RETURN status as indicted in logic block 306. In decision block 314, a determination of a STATE RETURN condition is made. A loop back to logic block 306 is made if the STATE Return is not received. If a STATE RETURN is received in decision block 314, then STATE RETURN information is processed and returned to the web application as indicated in logic block 316.

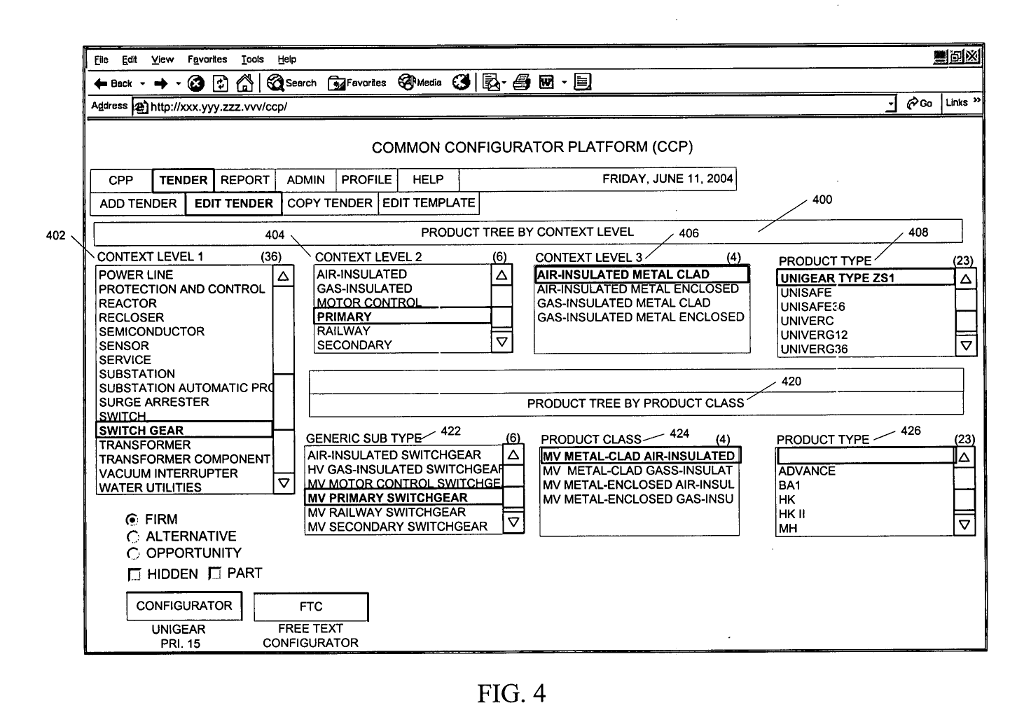

FIGS. 4-8 illustrate the user interface screens for an exemplary embodiment of the invention that can be used for web-based product configuration. FIG. 4 illustrates a user interface for a web-based common configurator platform which utilizes the present invention. The main sections of the user interface in the exemplary embodiment include “Product Tree By Context Level” 400 and “Product Tree By Product Class” 420. The “Product Tree By Context level” 400 section has multiple menus 402, 404, 406 representing different context levels in a hierarchical tree. As shown in product type menu 408 in FIG. 4, the user has selected a “UniGear Type ZS1” switchgear product for configuration, e.g., in response to a customer request for a switchgear price quote. The “Product Tree By Product Class” section 420 has multiple menus as well, e.g., generic sub-type menu 422 and product class menu 424. Product type in this hierarchical structure is selected in menu 426. As a point of reference for viewing FIG. 4, the UniGear type ZS1 is a medium voltage, air-insulated, metal clad switchboard technology for primary distribution, available from ABB, Inc.

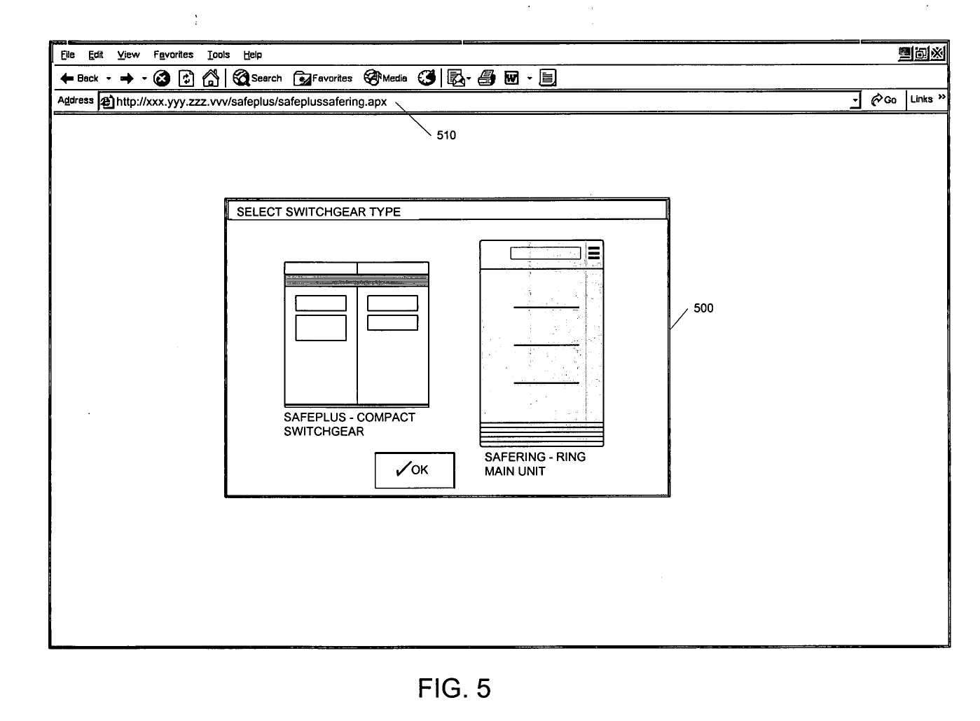

Following selection of a product type using the user interface depicted in FIG. 4, the user now goes to a product configurator in a local Windows application. In FIG. 5, a Windows application has received the STATE file and is opening. The user is presented with window 500 displaying the selected switchgear type. The Uniform Resource Locator (URL) for page Y is displayed in address window 510. The common configurator platform using the present invention has submitted to page X and the STATE file has been created.

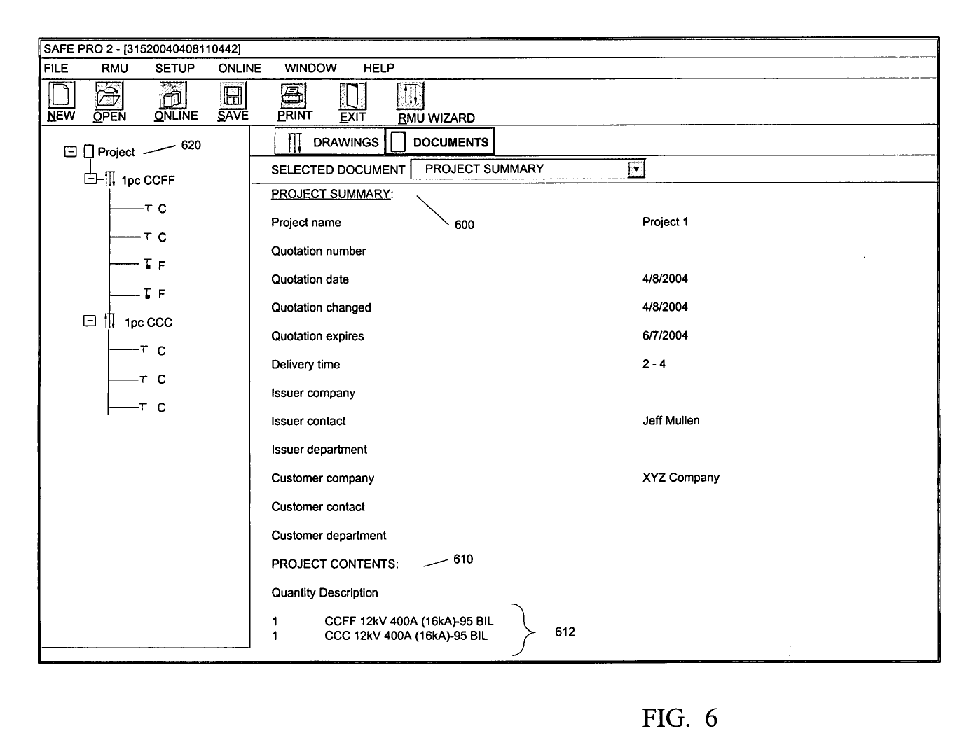

FIG. 6 shows project summary information in the Windows application which is then saved by the user. As shown for the product configurator exemplary embodiment, the user interface includes a “Project Summary” section 600, a “Project Contents” section 610, and a “Project Configuration” section 620. The “Project Contents” section 610 itemizes the products selected for the price quote. These products are indicated by reference numeral 612. The same products are identified in the “Project Configuration” section 620.

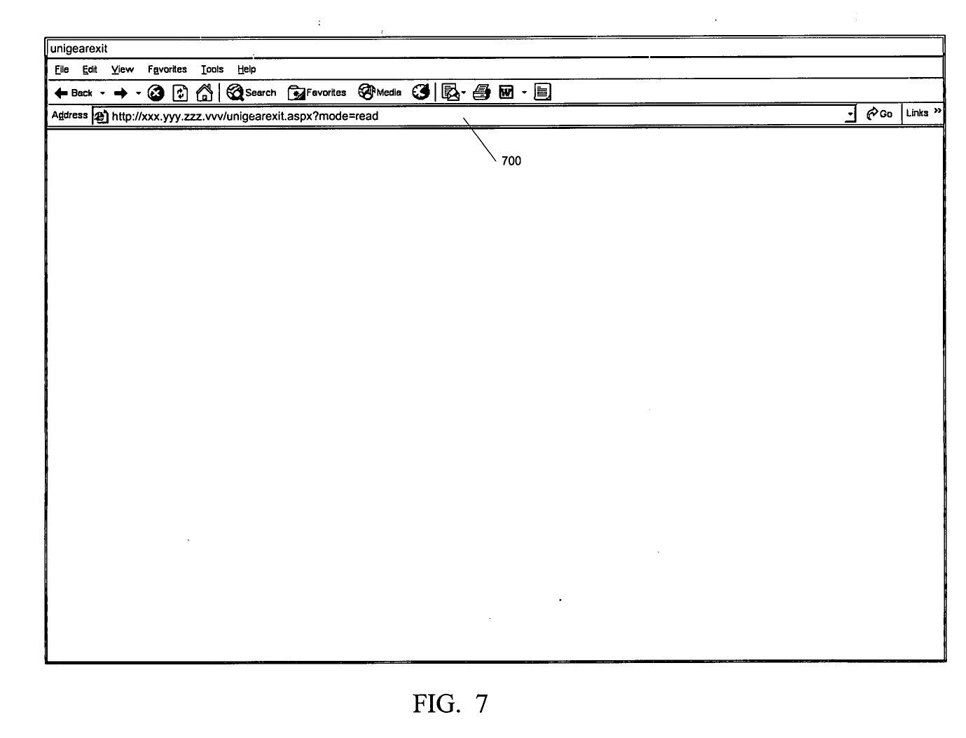

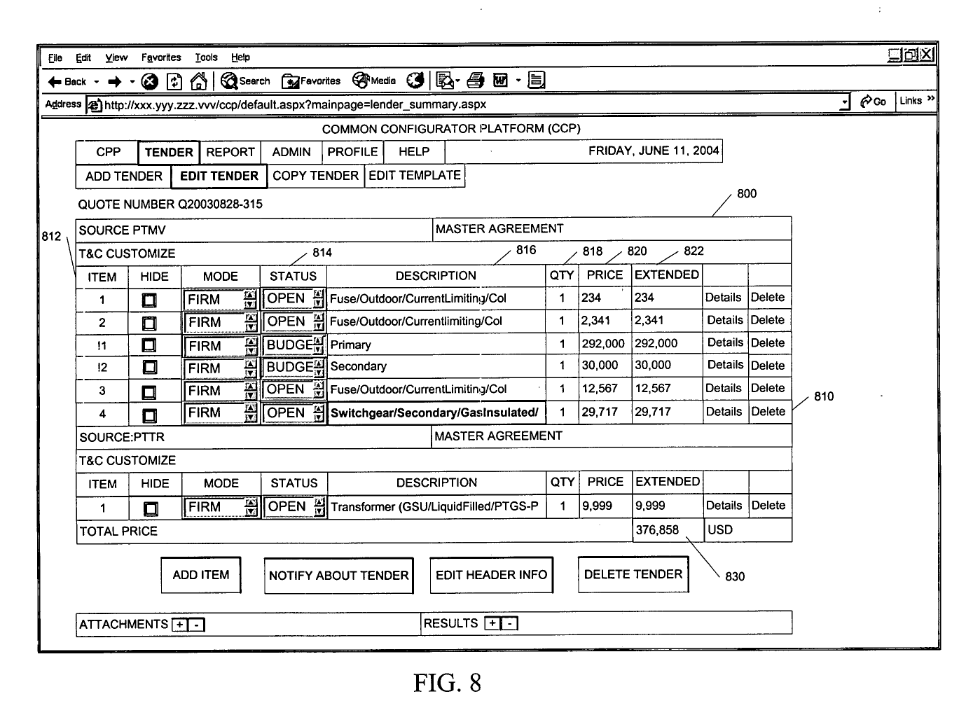

In FIG. 7, page Y has found the STATE RETURN file and redirects to page Z which reads the file. The URL for page Z in read mode is indicated in address window 700. When page Z finishes, the user is returned to the item list page shown in FIG. 8. This page includes the item 810 with product information from the Windows application. The item 810 is a compact, medium voltage switchgear for secondary distribution that is gas-insulated, such as the SafeLink ring main unit available from ABB, Inc. The main window depicted on this common configurator platform user interface screen is a product quote section 800. Also shown in the product quote section 800 is an item number field 812, an item status field 814, an item description field 816, an item quantity field 818, an item price field 820, an extended item price field 822 (for multiple units) and a total price estimate field 830 for the product quote.

The present invention can be implemented using commercially available server products, such as Internet Information Server available from Microsoft Corporation, and commercially available client devices, including workstations, personal computer, laptops, personal digital assistants, etc., without limitation.

The corresponding structures, materials, acts, and equivalents of all means plus function elements in any claims below are intended to include any structure, material, or acts for performing the function in combination with other claim elements as specifically claimed.

Those skilled in the art will appreciate that many modifications to the exemplary embodiments of the present invention are possible without departing from the spirit and scope of the present invention.

What is claimed:

1. A method for communicating between a web-based application and a client application and maintaining a client session with a web server, comprising the steps of:
initiating a unique client session with the web server;
requesting a first web page having information for use by the client application;
redirecting a client web browser to a second web page to prevent the client session with the web server from expiring;
generating a web form including a link to a file on the web server containing the information for use by the client application;
downloading the file to the client and executing the client application;
returning results generated from execution of the client application to the web server; and
processing the results returned to the web server from the client application.

2. The method for communicating between a web-based application and a client application of claim 1 further comprising the step of reloading the second page on a regular basis during the client session to maintain the session as active on the server.

3. The method for communicating between a web-based application and a client application of claim 2 further comprising the step of maintaining a count of the number of reloads of the second page.

4. The method for communicating between a web-based application and a client application of claim 3 wherein the step of generating a form is performed by the second web page when the count is zero.

5. The method for communicating between a web-based application and a client application of claim 3 wherein the step of generating a form is performed on the first load of the second web page.

6. The method for communicating between a web-based application and a client application of claim 1 wherein the form submits to itself with a time delay between each submission.

7. The method for communicating between a web-based application and a client application of claim 1 wherein the step of executing the client application is automatically started when the client accepts the file download.

8. The method for communicating between a web-based application and a client application of claim 1 further comprising the step of determining when the client application has completed execution using the information in the downloaded file.

9. The method for communicating between a web-based application and a client application of claim 8 wherein the step of determining comprises executing a program instruction that checks for a return criterion.

10. The method for communicating between a web-based application and a client application of claim 1 wherein the step of redirecting a web browser to a second web page comprises executing a program instruction to reload the second web page until a return criterion from the client application is detected.

11. The method for communicating between a web-based application and a client application of claim 1 wherein the step of executing the client application comprises operating the client application with the information contained in the downloaded file.

12. The method for communicating between a web-based application and a client application of claim 1 wherein the step of returning results from the client application comprises executing a web-based posting method.

13. The method for communicating between a web-based application and a client application of claim 1 wherein the step of returning results comprises storing the results on the web server to preserve session information.

14. The method for communicating between a web-based application and a client application of claim 13 further comprising the step of the redirecting the web browser to continue the communication session with the web-based application.

15. The method for communicating between a web-based application and a client application of claim 1 wherein the client application is a non-browser application resident on a client device.

16. The method for communicating between a web-based application and a client application of claim 13 wherein the web-based posting method uses a Hypertext Transfer Protocol (HTTP).

17. A method for integrating a non-browser application with an application executing on a web server and maintaining a session state, comprising the steps performed by the web server of:
receiving a request from a client web browser for a first web page for use by the non-browser application;
processing the data needed for the non-browser application and generating a state file;
redirecting the client web browser to a second web page to maintain the session state;
downloading the state file to the client browser to initiate the non-browser application;
receiving information posted by the non-browser application;
creating a state return file containing session information; and
redirecting the web browser to the application executing on the web server.

18. The method for integrating a non-browser application with an application executing on a web server of claim 17 further comprising the step of reloading the second page on a regular basis during the session to maintain the session as active on the server.

19. The method for integrating a non-browser application with an application executing on a web server of claim 18 further comprising the step of maintaining a count of the number of reloads of the second page.

20. The method for integrating a non-browser application with an application executing on a web server of claim 17 further comprising the step of determining when the non-browser application has completed execution using the data in the downloaded state file.

21. The method for integrating a non-browser application with an application executing on a web server of claim 20 wherein the step of determining comprises executing a program instruction that checks for a return criterion.

22. The method for integrating a non-browser application with an application executing on a web server of claim 17 wherein the step of redirecting the client web browser to a second web page comprises executing a program instruction to reload the second web page until a return criterion from the client application is detected.

23. The method for integrating a non-browser application with an application executing on a web server of claim 17 wherein the state file contains a marker that associates the state file with the session and the data needed for the non-browser application.

24. The method for integrating a non-browser application with an application executing on a web server of claim 17 wherein the state return file contains session information that correlates the state file with the state return file.

25. A computer program product for integrating a non-browser application with an application executing on a web-server and maintaining a session state, comprising a computer usable medium having computer readable code embodied therein, the computer usable medium comprising:
program instructions that receive a request from a client web browser for a first web page for use by the non-browser application;
program instructions that process the data needed for the non-browser application and generate a state file;
program instructions that redirect the client web browser to a second web page to maintain the session state;
program instructions that download the state file to the client browser to initiate the non-browser application;
program instructions that receive information posted by the non-browser application;
program instructions that create a state return file containing session information; and
program instructions that redirect the web browser to the application executing on the web server.

26. The computer program product for integrating a non-browser application with an application executing on a web server of claim 25 further comprising program instructions that reload the second page on a regular basis during the session to maintain the session as active on the server.

27. The computer program product for integrating a non-browser application with an application executing on a web server of claim 25 further comprising program instructions that maintain a count of the number of reloads of the second page.

28. The computer program product for integrating a non-browser application with an application executing on a web server of claim 25 further comprising program instructions that determine when the non-browser application has completed execution using the data in the downloaded state file.

29. The computer program product for integrating a non-browser application with an application executing on a web server of claim 28 wherein the program instructions that determine include program instructions that check for a return criterion.

30. The computer program product for integrating a non-browser application with an application executing on a web server of claim 25 wherein the program instructions that redirect the client web browser to a second web page include program instructions that reload the second web page until a return criterion from the client application is detected.

31. The computer program product for integrating a non-browser application with an application executing on a web server of claim 25 wherein the program instructions that generate the state file insert a marker that associates the state file with the session and the data needed for the non-browser application.

32. The computer program product for integrating a non-browser application with an application executing on a web server of claim 25 further comprising program instructions that correlate the state file with the state return file using session information contained in the state return file.
